(19) United States
(12) Patent Application Publication
(10) Pub. No.: US 2005/0153712 A1
(43) Pub. Date: Jul. 14, 2005

(54) Method and system for determining mobile unit location by aggregation of tagged signals from a distributed antenna system

(76) Inventors: Ken Osaka, Tsukubashi (JP); Simon Pui Sang Yeung, Cupertino, CA (US); David Hart, Sunnyvale, CA (US); Akira Katsurashima, Natorishi (JP)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/754,279

(22) Filed: Jan. 8, 2004

(51) Int. Cl. H04Q 7/20; H04M 11/00

(52) U.S. Cl. 455/456.5; 455/456.1

(57) ABSTRACT

A method for determining the location of a mobile unit tags uplink signals received at separate antennas with corresponding antenna tags. All of the uplink signals are combined into a single combined signal, which may be transmitted to a base station. One or more signal parts are selected from the combined signal, and these selected parts are decoded to determine their corresponding antenna tags. A location algorithm is applied to the decoded signal parts to determine a location of the mobile unit.

### FIELD OF THE INVENTION

This invention relates to methods and systems for location determination of a mobile wireless unit.

### BACKGROUND

FIG. 1 is a side view of a building 10 having a typical wireless communication infrastructure including antennas 12, links 14, remote units 16, a backbone connection 18, and a base station 20. In operation, base station 20 can transmit a signal along backbone connection 18 which is received by all of the remote units 16. The signal is transmitted in turn along all of links 14, and radiated by all of antennas 12. The signal broadcasted by antennas 12 is received by a mobile unit (not shown). Communication from base station to mobile unit is conventionally referred to as a downlink. Thus the arrangement of FIG. 1 is suitable for downlink broadcasting, where the signal is broadcasted from all of antennas 12 and will reach any mobile unit that is in a region covered by any of antennas 12.

Communication from a mobile unit to a base station is conventionally referred to as an uplink. A signal emitted by the mobile unit that is received by any of antennas 12 will reach the base station, so the arrangement of FIG. 1 is also suitable for uplink communication from a mobile unit that is in range (i.e., within a region covered by any of antennas 12).

The key architectural feature of the arrangement of FIG. 1 is that all signals received at (or transmitted by) antennas 12 are combined into a single combined signal that is sent via backbone 18 to (or from) base station 20.

FIG. 2 is a block diagram of a typical multilayer wireless communication infrastructure which serves two (or more) microcell coverage regions 24. Each region 24 includes several antennas 12 and links 14 between antennas 12 and a hub 26. In uplink operation to a mobile unit (not shown), each hub 26 provides a hub combined signal 28 which is received by a combiner 30. Combiner 30 combines all of the hub combined signals to provide a single combined signal 32 which is received by base station 20. An exemplary application of the arrangement of FIG. 2 is an airport, where regions 24 correspond to separate terminals of the airport. In addition to uplinking, the arrangement of FIG. 2 provides downlinking to the mobile unit.

Again, the key architectural feature of the arrangement of FIG. 2 is that all uplink signals received at antennas 12 are combined into a single combined signal 32 that is sent to base station 20. In downlink, each signal is sent to all of hubs 26 and then broadcast from all of antennas 12. We refer to architectures having this feature as distributed antenna systems. Many existing wireless communication systems include such distributed antenna systems.

There is an increasing need for wireless communication systems to provide location information for mobile units, driven in some cases by regulatory pressure (e.g., 911 regulations), and in other cases by a desire to provide location based services to mobile units. Accordingly, various methods for determining mobile unit location are known. These methods include: received signal strength (RSS), cell of origin (COO), time of arrival (TOA), time difference of arrival (TDOA), enhanced observed time difference (E-OTD), angle of arrival (AOA), and enhanced forward link triangulation (EFLT).

All of these methods may be implemented in a system represented by the block diagram shown in FIG. 3. In FIG. 3, n antennas A_1, A_2, . . . , A_n (shown as 34, 36, . . . , 38 respectively) are in communication with a location processor 46. Location processor 46 separately receives signals S1, S2, . . . , Sn (shown as 40, 42, . . . , 44 respectively) from antennas 34, 36, . . . , 38, with no combination. Within location processor 46, a location algorithm (e.g., one of the methods listed above) is applied to the separately received signals to determine location.

However, these location determination methods are not directly applicable to distributed antenna systems. The reason for this inapplicability is that, in a distributed antenna system, the identity of the receiving antenna for each uplink signal is lost in the process of aggregating all of the uplink signals into a single combined signal received by base station 20. Because the location determination methods require knowledge of which antenna is associated with each uplink signal, they do not function in a distributed antenna system.

Accordingly, it would be an advance in the art to provide location information in a wireless communication system having a distributed antenna system.

### SUMMARY

In one aspect, the present invention provides a method for determining the location of a mobile unit where each uplink signal received at an antenna is tagged with a corresponding unique antenna tag. All of the tagged uplink signals are combined into a single combined signal, which may be communicated to a base station. One or more signal parts are selected from the combined signal, and these selected parts are decoded to determine their corresponding antenna tags. A location algorithm is applied to the decoded signal parts to determine a location of the mobile unit.

### BRIEF DESCRIPTION OF THE DRAWINGS

FIG. 1 shows a typical single-layer wireless communication system having a distributed antenna system.

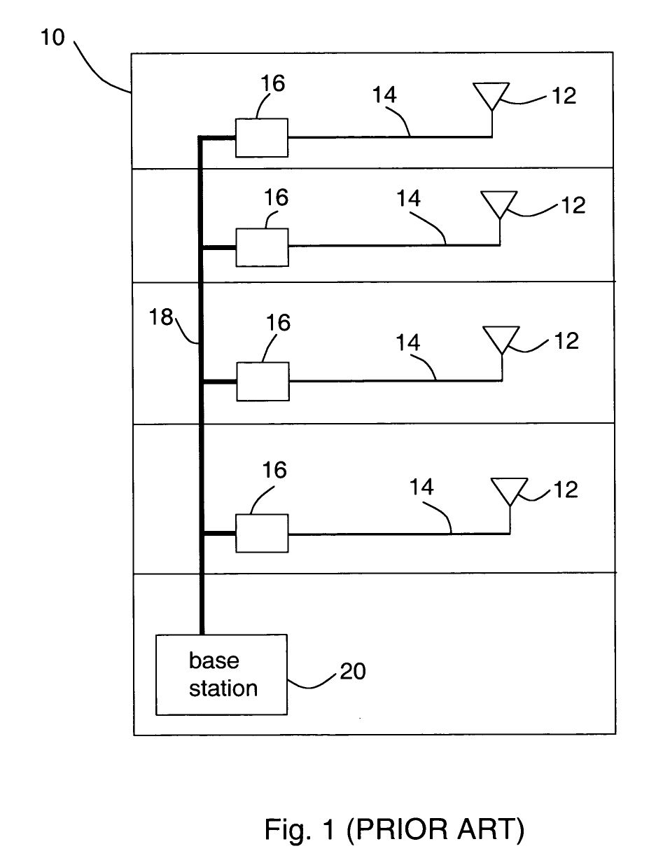

FIG. 2 shows a typical multi-layer wireless communication system having a distributed antenna system.

FIG. 3 is a block diagram of the architecture used with prior art location determination methods.

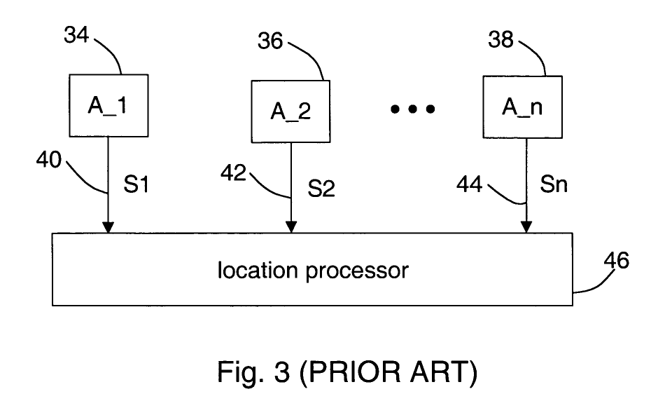

FIG. 4 is a block diagram of a location determination system in accordance with an embodiment of the invention.

FIG. 5 is a block diagram of a single-layer location determination system in accordance with another embodiment of the invention.

FIG. 6 is a block diagram of a two-layer location determination system in accordance with yet another embodiment of the invention.

### DETAILED DESCRIPTION

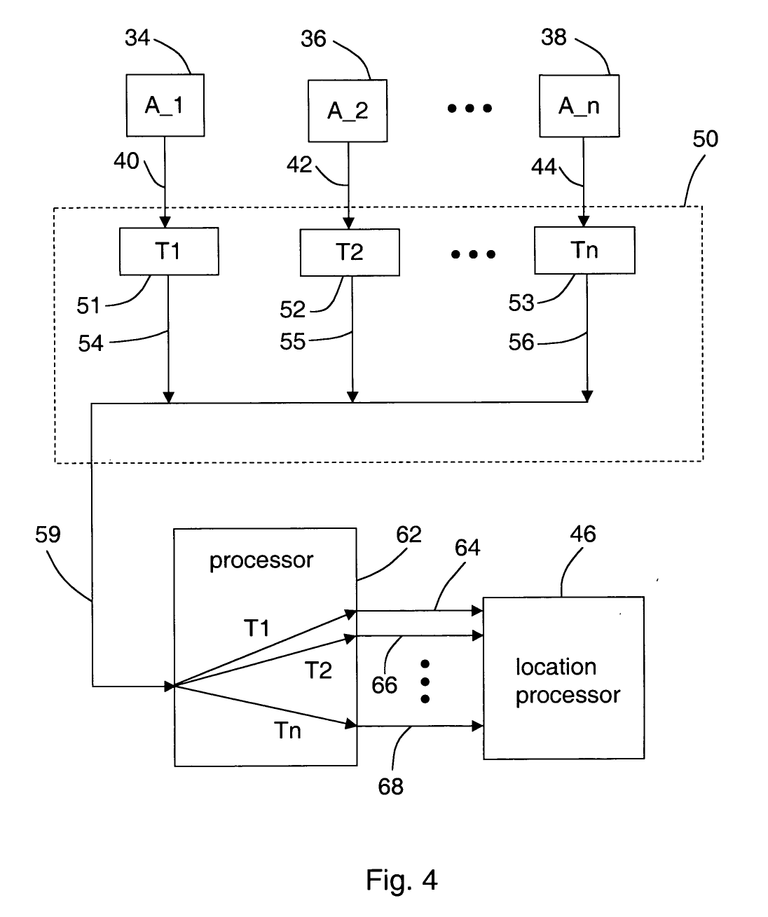

FIG. 4 is a block diagram of a location determination method in accordance with an embodiment of the invention. A plurality of n antennas A_1, A_2, . . . , A_n (shown as 34, 36, . . . , 38 respectively) provide a plurality of n corresponding uplink signals 40, 42, . . . , 44, respectively. The plurality of uplink signals is received by a combining and encoding block 50. Within block 50, a plurality of encoding circuit blocks 51, 52, . . . , 53 respectively impose unique tags T1, T2, . . . , Tn on uplink signals 40, 42, 44 respectively to provide encoded signals 54, 55, . . . , 56 respectively. No two of antenna tags T1, T2, . . . , Tn are the same. Encoded signals 54, 55, . . . , 56 are then combined in block 50 into a single combined signal 59. The encoding of the n uplink signals with the n unique antenna tags T1, T2, . . . , Tn can be implemented in various ways, including but not limited to encoding each uplink signal with: a unique time delay; a unique frequency shift; or a unique modulation of amplitude, frequency and/or subcarrier. Digital tagging by adding a digital header or digital code to the signals is another applicable encoding method.

Combined signal 59 is received by a processor 62, which selects one or more signal parts, shown as 64, 66, . . . , 68 on FIG. 4, of combined signal 59 and decodes the selected signal parts to determine which of the antenna tags corresponds to the selected signal parts. The selection of the signal parts may be directly based on the antenna tags (e.g., if processor 62 is a time delay demultiplexor and the antenna tags are time delays). Alternatively, this selection may be based on any characteristic(s) of the signal that permit selection, including but not limited to: received power, bit error rate, Quality, first time of arrival or any combination thereof.

Signal parts 64, 66, . . . , 68 correspond to uplink signals 40, 42, . . . , 44 received at antennas 34, 36, . . . , 38. Signal parts 64, 66, . . . , 68 are received by a location processor 46, which determines the location of the mobile unit from its separated inputs 64, 66, . . . , 68 and from known locations of antennas 34, 36, . . . , 38. Location processor 46 need not receive inputs corresponding to all of antennas 34, 36, . . . , 38. Instead, as indicated above, processor 62 selects one or more signal parts to pass on to location processor 46, along with decoded antenna tag information for the selected signal parts. Suitable location algorithms for location processor 46 include, for example: received signal strength (RSS), cell of origin (COO), time of arrival (TOA), time difference of arrival (TDOA), and enhanced observed time difference (E-OTD).

The system illustrated in the block diagram of FIG. 4 may be implemented in hardware in many different ways. For example, FIG. 4 shows several point to point links (e.g., transmission from antenna 34 to combining and encoding block 50). Such point to point links can include, for example, electrical wiring, optical fiber, an RF free space link and/or an optical free space link. Similarly, location processor 46 can be any combination of hardware and/or software suitable for determining mobile unit location based on known locations of antennas 34, 36, 38 and separated inputs 64, 66, . . . , 68 corresponding to antennas 34, 36, . . . , 38 respectively.

The embodiment of FIG. 4 provides various advantages. For example, the region within which the plurality of antennas 34, 36, . . . , 38 are disposed can be either a two-dimension area or a three dimensional volume (e.g., within a building). Since prior art location determination methods tend to be directed to location within an area, providing location within a volume is an advance in the art. It is also an advance in the art to provide reliable location determination within a building, since prior art location determination methods tend to fail inside buildings, due in part to severe multipath effects and signal attenuation.

In some cases, it is advantageous for location processor 46 to include an antenna location database from which antenna location information can be retrieved. Such a database also provides a useful tool for managing and updating antenna location information, especially for a large scale system having a large number of antennas.

Location processor 46 can advantageously be connected to an external network to provide mobile unit location information to the external network. The external network (or any service provider on the external network) can then provide location based services to the mobile unit based on location information provided by location processor 46 to the network.

The accuracy of the location information provided by the embodiment of FIG. 4 depends in part on the number and spacing of antennas 34, 36, . . . , 38. Increased location accuracy can be obtained by reducing the spacing between these antennas.

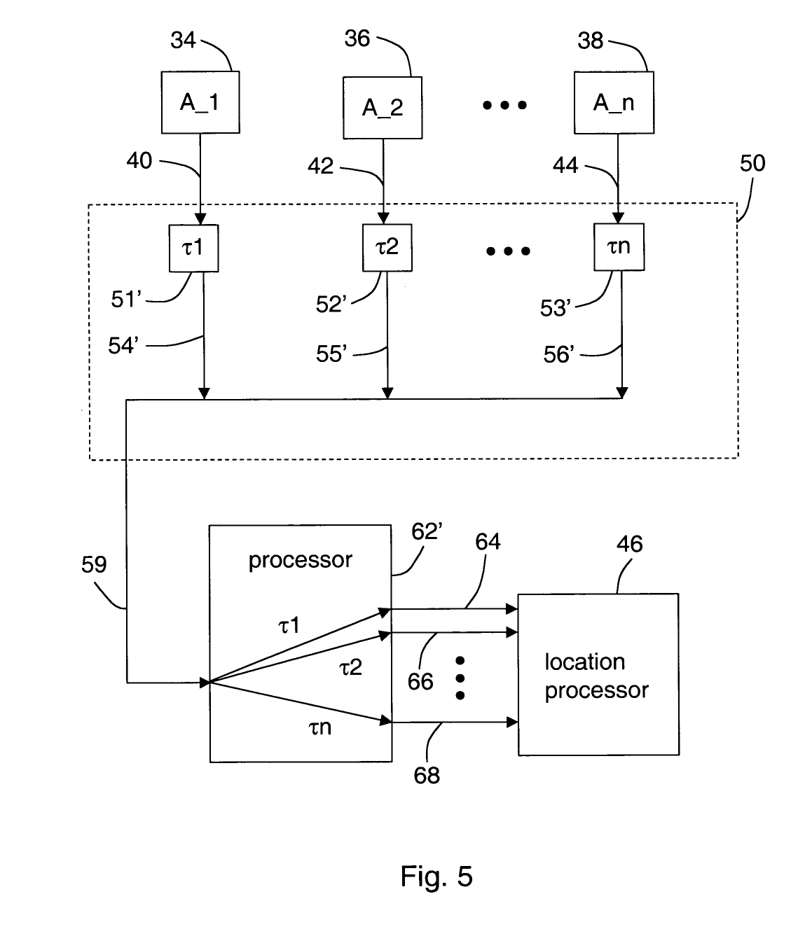

FIG. 5 is a block diagram illustrating one embodiment of the invention using time delay tags. In FIG. 5, predetermined and unique time delays τ1, τ2, . . . , τn are imposed by encoding circuit blocks 51′, 52′, . . . , 53′ respectively on uplink signals 40, 42, . . . , 44 respectively to provide delayed signals 54′, 55′, . . . , 56′ respectively. Delayed signals 54′, 55′, . . . , 56′ are combined to provide combined signal 59 to a processor 62′. In this embodiment, processor 62′ is a time division demultiplexor to separate combined signal 59 into signal parts 64, 66, . . . , 68 according to predetermined delays τ1, τ2, . . . , τn respectively. Delays τ1, τ2, . . . , τn corresponding to antennas 34, 36, . . . , 38 in FIG. 5 are defined as the total delays between the corresponding antennas and processor 62′. Such total delays include time of flight along electrical cable and/or optical fiber, as well as any delays provided by one or more lumped delay elements. Lumped delay elements are convenient for setting the total delay of a path to a desired value. In some cases, time of flight delay can be adjusted to set the total delay appropriately (e.g., by choosing optical fiber lengths and/or electrical cable lengths appropriately).

Lumped elements for adjusting total delays of delayed signals 54′, 55′, . . . , 56′ may be, for example, commercially available surface acoustic wave (SAW) filters. In some cases, SAW filters can be used having a bandwidth much larger than the uplink or downlink bandwidth to the mobile unit, which reduces the effect of the SAW filter on the communication link to the mobile unit. Also in some cases, uplink signals 40, 42, . . . , 44 may be down-converted from radio frequency (RF) to an intermediate frequency (IF) before adjusting the delays to τ1, τ2, . . . , τn respectively with SAW filters, since SAW filters at IF tend to be more readily available. Alternatively, elements for adjusting delays of delayed signals 54′, 55′, . . . , 56′ can be digital delay elements, where the corresponding uplink signal is digitized, digitally delayed, and then converted to an analog signal with a D/A converter. Other delay elements can also be used to practice the invention, such as electrical delay lines, optical fibers and digital delay elements, and of course there is no requirements that the same technology be used for all delay elements in the system. For example, encoding circuit block 51′ could be a SAW filter, and encoding circuit block 52′ could be a digital delay element.

Processor 62′ on FIG. 5 provides time division demultiplexing of combined signal 59 to provide signal parts 64, 66, . . . , 68 corresponding to antennas 34, 36, 38 respectively. One method for performing this demultiplexing is to sample combined signal 59 at a suitable sampling rate and then time delay demultiplex the sampled signal using standard digital signal processing methods.

To illustrate an aspect of this embodiment, suppose, for example, the mobile unit emits a pulse of radiation which is received by only one of antennas 34, 36, . . . , 38. A delay corresponding to the antenna that received the pulse is imposed on the corresponding uplink signal by block 50. In this example, combined signal 59 is an appropriately delayed pulse. Processor 62′ detects a pulse, and may determine the time delay of that pulse using some information about when the pulse was emitted by the mobile unit.

Such timing information can be provided in various ways. For example, in a system where the mobile unit and remote units are all synchronized to a master clock, the system knows when the pulse was emitted by the mobile unit. Therefore the delay tag applied to the selected signal can be determined from the time difference between the known transmission time and the time of arrival of the selected signal. An alternative method is switch the delay tags on and off, so that delayed signals are received by processor 62′ at some times and non-delayed signals are received by processor 62′ at other times. In this arrangement, processor 62′ can determine the time delay tag from the difference in time of arrival of the delayed and non-delayed versions of the signals. Yet another alternative is for the remote units to provide both delayed and non-delayed signals for inclusion in the combined signal. In this case as well, processor 62′ can determine the time delay tag from the difference in time of arrival of the delayed and non-delayed versions of the signals.

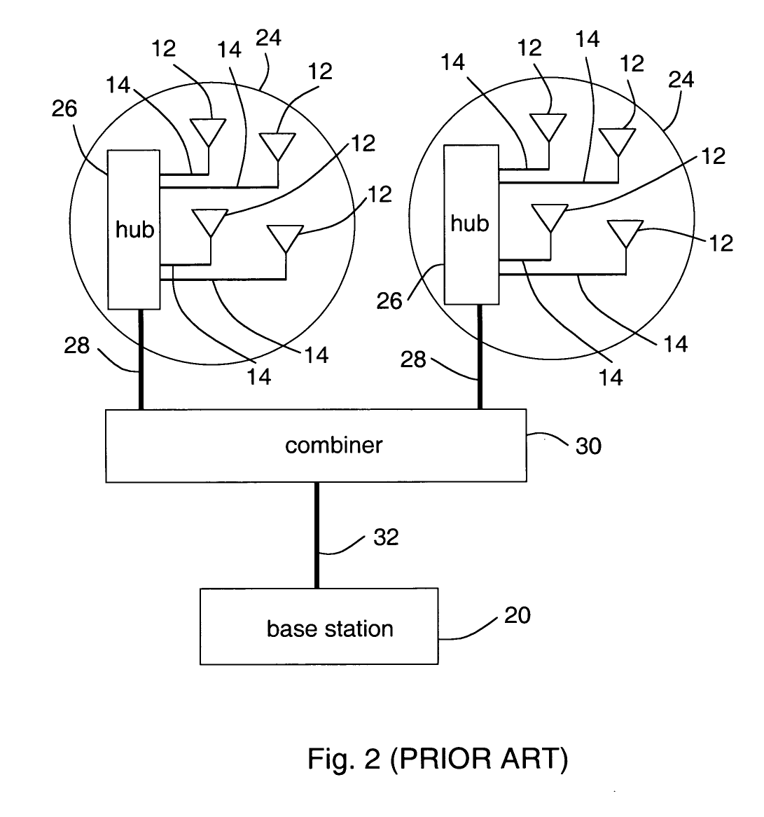

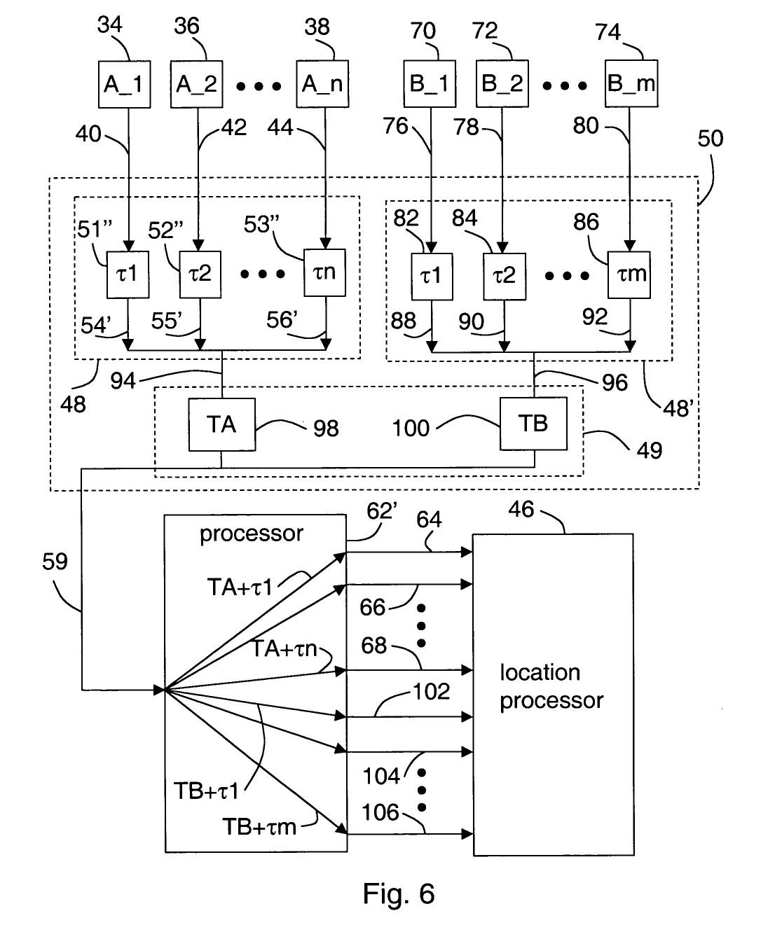

FIG. 6 is a block diagram of a second embodiment making use of time delays as tags for the uplink signals. In this second version, encoding and combining are done in two stages, as would be suitable for a two level distributed antenna system as shown in FIG. 2. The configuration of FIG. 6 has two subsets of antennas, subset A including antennas A_1, A_2, . . . , A_n (labeled 34, 36, . . . , 38 respectively), and subset B, including antennas B_1, B_2, . . . , B_m (labeled 70, 72, . . . , 74 respectively. Combining and encoding block 50 in FIG. 6 has two levels of combining and encoding.

Signals from subset A are received by combining and encoding sub-block 48. Delays τ1, τ2, . . . , τn, are imposed by encoding circuit blocks 51″, 52″, . . . , 53″ respectively, on uplink signals 40, 42, . . . , 44 respectively to provide delayed signals 54′, 55′, . . . , 56′ that are combined to provide an intermediate combined signal 94. The delays provided by encoding circuit blocks 51″, 52″, . . . , 53″ in FIG. 6 are defined to be total delays between antennas 34, 36, . . . , 38 respectively and intermediate combined signal 94.

Signals from subset B are received by combining and encoding sub-block 48′. Delays τ1, τ2, . . . , τm, are imposed by encoding circuit blocks 82, 84, . . . , 86 respectively, on uplink signals 76, 78, . . . , 80 respectively to provide delayed signals 88, 90, . . . , 92 that are combined to provide an intermediate combined signal 96. The delays provided by encoding circuit blocks 82, 84, . . . , 86 in FIG. 6 are defined to be total delays between antennas 70, 72, 74 respectively and intermediate combined signal 96.

Intermediate signals 94 and 96 are received and combined by an intermediate combining block 49, which provides combined signal 59. In some cases, block 49 also imposes time delays on the intermediate combined signals. For example, in FIG. 6 time delays TA and TB are imposed on intermediate combined signals 94 and 96, corresponding to subsets A and B respectively. Delays TA and TB are defined to be the total delays between intermediate combined signals 94 and 96 respectively, and combined signal 59.

Combined signal 59 is received by processor 62′, and time delay demultiplexed. In the example of FIG. 6, the sums TA+τ1, TA+τ2, . . . , TA+τn, TB+τ1, TB+τ2, . . . , TB+τm are distinct to permit an unambiguous separation of combined signal 59 into signal parts (shown as 64, 66, . . . , 68 and 102, 104, . . . , 106 in FIG. 6) corresponding to each antenna. There are many ways to provide unique total delays. One method is to make the difference between TA and TB larger than the difference between τ1 and τn, so TA and TB effectively act as the coarse delay adjustment and τ1 through τn (or τm) effectively act as the fine delay adjustment. In this case, the time delays imposed in sub-block 48 can be the same as those imposed in sub-block 48′ (as in the example of FIG. 6).

In the example of FIG. 6, the antenna tag corresponding to a particular antenna, called antenna X, includes a subset time delay (i.e., TA or TB) to identify the subset antenna X belongs to, and a member time delay (i.e., τ1, τ2, . . . ) to identify which antenna within this subset is antenna X. More generally, in an embodiment of the invention having two levels of combining and encoding, an antenna tag can include a member tag and a subset tag. Similarly, in an embodiment having N levels of combining and encoding, an antenna tag can include N subtags corresponding to the N levels of encoding and combining.

The above description of embodiments of the invention is illustrative, rather than restrictive. Many alternatives fall within the scope of the present invention. For example, in the embodiments of FIGS. 5 and 6, processor 62′ is a time delay demultiplexor, but such demultiplexing is not required to practice the invention. Instead, as indicated in connection with FIG. 4, processor 62 may select one or more signal parts, and then decode these selected signal parts to determine the corresponding antenna tags. Clearly, a full demultiplexing of the combined signal is not required to perform these functions.

1. A method for determining the location of a mobile unit within a region, the method comprising:
a) receiving at a plurality of antennas having known locations within said region a corresponding plurality of uplink signals originating from the mobile unit;
b) encoding each of said uplink signals with an antenna tag corresponding to each of said plurality of antennas;
c) combining the encoded uplink signals into a single combined signal;
d) selecting one or more signal parts of said combined signal;
e) decoding said signal parts to determine which of said antenna tags corresponds to each of said signal parts; and
f) determining said location in part from said known locations of said plurality of antennas, said signal parts, and said decoding.

2. The method of claim 1, wherein said region is an indoor region.

3. The method of claim 1, wherein said region is a two dimensional area.

4. The method of claim 1, wherein said region is a three dimensional volume.

5. The method of claim 1, wherein said determining comprises retrieving said known locations from a database of known antenna locations.

6. The method of claim 1, further comprising providing said determined location to a network.

7. The method of claim 6, further comprising providing a location based service to said mobile unit by said network.

8. The method of claim 1, wherein said combining comprises:
i) providing a partitioning of said antennas into subsets of antennas, wherein each of said antennas is a member of one of said subsets;
ii) combining said encoded uplink signals to generate a set of intermediate combined signals, wherein each intermediate combined signal is obtained by combining encoded uplink signals received from one of the subsets of antennas; and
iii) combining said intermediate combined signals to provide said combined signal.

9. The method of claim 8, wherein said encoding each of said uplink signals with an antenna tag comprises: providing a member tag for each antenna in each of said subsets, and providing a subset tag for each of said subsets, wherein no two antennas of said plurality have the same combination of member tag and subset tag.

10. The method of claim 9, wherein said providing a member tag comprises providing a member time delay, and wherein said providing a subset tag comprises providing a subset time delay, wherein no two antennas of said plurality have the same sum of member time delay and subset time delay.

11. The method of claim 9, wherein said providing a member tag comprises providing a member frequency shift, and wherein said providing a subset tag comprises providing a subset frequency shift, wherein no two antennas of said plurality have the same sum of member frequency shift and subset frequency shift.

12. The method of claim 1, wherein said determining a location uses a location algorithm selected from the group consisting of received signal strength, cell of origin, time of arrival, time difference of arrival, and enhanced observed time difference.

13. The method of claim 1, wherein said antenna tag is selected from the group consisting of: a unique time delay, a unique frequency shift, a unique modulation, a unique digital header, and a unique digital code.

14. The method of claim 1, wherein said encoding each of said uplink signals with an antenna tag comprises passing each of said uplink signals through a surface acoustic wave (SAW) delay element.

15. The method of claim 14, further comprising frequency down-converting one of said uplink signals to an intermediate frequency before said one signal passes through said SAW delay element.

16. The method of claim 1, wherein said encoding each of said uplink signals with an antenna tag comprises passing each of said uplink signals through a digital delay element.

17. A wireless communication system capable of providing location information for a mobile unit within a region, the system comprising:
a) a plurality of antennas having known locations within said region for receiving a plurality of uplink signals transmitted from the mobile unit;
b) a plurality of encoding circuit blocks coupled to the plurality of antennas, wherein the encoding circuit blocks impose antenna tags on the uplink signals;
c) a combining circuit block connected to the encoding circuit blocks to receive said encoded uplink signals and output a single combined signal;
d) a processor in communication with the combining circuit block for receiving said combined signal, selecting one or more signal parts of said combined signal, and decoding said signal parts to determine which of said antenna tags corresponds to each of said signal parts; and
e) a location processor connected to the processor to receive said signal parts, wherein the location processor determines said location information in part from said known antenna locations, said signal parts, and said decoding using a location algorithm.

18. The system of claim 17, wherein said region is an indoor region.

19. The system of claim 17, wherein said region is a two dimensional area.

20. The system of claim 17, wherein said region is a three dimensional volume.

21. The system of claim 17, wherein said location processor further comprises a database of known antenna locations.

22. The system of claim 17, further comprising a network connected to said location processor, wherein the network receives said determined location from said location processor.

23. The system of claim 22, wherein said network provides a location based service to said mobile unit.

24. The system of claim 17, wherein said combining circuit block comprises:
i) a plurality of combining circuit sub-blocks for combining subsets of said encoded uplink signals into intermediate combined signals; and
ii) an intermediate combining block receiving the intermediate combined signals and producing said combined signal.

25. The system of claim 24, further comprising intermediate encoding blocks imposing subset tags upon said intermediate combined signals.

26. The system of claim 25, wherein each of said antenna tags comprises a member time delay, and wherein each of said subset tags comprises a subset time delay, wherein the sum of said member time delay and said subset time delay is unique.

27. The system of claim 25, wherein each of said antenna tags comprises a member frequency shift, and wherein each of said subset tags comprises a subset frequency shift, wherein the sum of said member frequency shift and said subset frequency shift is unique.

28. The system of claim 17, wherein said location algorithm is selected from the group consisting of received signal strength, cell of origin, time of arrival, time difference of arrival, and enhanced observed time difference.

29. The system of claim 17, wherein said antenna tag is selected from the group consisting of: a unique antenna time delay, a unique antenna frequency shift, a unique antenna modulation, a unique digital header, and a unique digital code.

30. The system of claim 17, wherein one of said encoding circuit blocks comprises a surface acoustic wave (SAW) delay element.

31. The system of claim 30, further comprising a frequency down-converter circuit connected to one of said antennas to down-convert one of the uplink signals to an intermediate frequency and provide the down-converted uplink signal to said SAW delay element.

32. The system of claim 17, wherein one of said encoding circuit blocks comprises a digital delay element.
